(19) United States
(12) Patent Application Publication
(10) Pub. No.: US 2015/0285631 A1
(43) Pub. Date: Oct. 8, 2015

(54) DISTANCE MEASURING APPARATUS, IMAGING APPARATUS, AND DISTANCE MEASURING METHOD

(71) Applicant: PANASONIC INTELLECTUAL PROPERTY MANAGEMENT CO., LTD., Osaka (JP)

(72) Inventors: Kenichi KUBOTA, Osaka (JP); Yoshihiro MORIOKA, Nara (JP); Yusuke ONO, Osaka (JP)

(21) Appl. No.: 14/743,979

(22) Filed: Jun. 18, 2015

Related U.S. Application Data
(63) Continuation of application No. PCT/JP2014/001278, filed on Mar. 7, 2014.

(30) Foreign Application Priority Data
Mar. 13, 2013 (JP) 2013-050012

(51) Int. Cl. G01C 3/08; H04N 13/02; H04N 5/225

(52) U.S. Cl. CPC G01C 3/085; H04N 5/2258; H04N 13/0239; H04N 13/025; H04N 13/0296

(57) ABSTRACT

An imaging apparatus includes the following elements: a display unit configured to be openable and closable; a primary imaging unit; a secondary imaging unit for outputting a secondary image signal that has an angle of view equal to or wider than that of a primary image and a resolution higher than that of the primary image; an angle-of-view matching unit for generating a cutout image signal from the secondary image signal, based on the primary image signal; a parallax information generator for generating parallax information, based on the primary image signal and the cutout image signal; and a distance measuring unit for calculating a distance to a predetermined object included in the primary image signal, based on the parallax information and the primary image signal. In this imaging apparatus, the secondary imaging unit is disposed on the backside of the image display surface of the display unit.

### BACKGROUND

1. Field of the Disclosure

The present disclosure relates to an imaging apparatus that includes a plurality of imaging units and is capable of imaging images for stereoscopic view.

2. Background Art

Unexamined Japanese Patent Publication No. 2005-20606 (Patent Literature 1) discloses a digital camera that includes a main imaging unit and a sub imaging unit and generates a 3D image. This digital camera extracts parallax generated between a main image signal obtained from the main imaging unit and a sub image signal obtained from the sub imaging unit. Based on the extracted parallax, the digital camera generates a new sub image signal from the main image signal. Then, the digital camera generates a 3D image using the main image signal and the new sub image signal.

Unexamined Japanese Patent Publication No. 2005-210217 (Patent Literature 2) discloses a stereoscopic camera capable of stereoscopic photography with the right and left photographing magnifications different from each other. This stereoscopic camera includes a primary imaging means for generating primary image data, and a secondary imaging means for generating secondary image data that has an angle of view wider than that of the primary image data. The stereoscopic camera cuts out, from the secondary image data, the range corresponding to the primary image data, as third image data. Then, the stereoscopic camera generates stereoscopic image data using the primary image data and the third image data.

Each of Patent Literatures 1 and 2 discloses a configuration in which the main imaging unit (primary imaging means) has an optical zoom function and the sub imaging unit (secondary imaging means) has no optical zoom function and has an electronic zoom function.

Unexamined Japanese Patent Publication No. 2006-93859 (Patent Literature 3) discloses an electronic camera including a twin lens imaging system. This electronic camera includes a zoom lens and a single-focus, fixed-focus sub lens, and measures a distance, based on the image captured through the zoom lens and the image captured through the sub lens.

### SUMMARY

The present disclosure provides a distance measuring apparatus and an imaging apparatus each capable of measuring a distance, based on a pair of images or a pair of moving images imaged by a pair of imaging units whose optical characteristics and specifications for respective imaging devices are different from each other.

The distance measuring apparatus of the present disclosure includes an angle-of-view matching unit, a parallax information generator, a plurality of lookup tables, and a distance measuring unit. The angle-of-view matching unit is configured to receive a primary image signal and a secondary image signal and to generate a cutout image signal, based on the primary image signal, by cutting out at least part of the secondary image signal. The secondary image signal has a resolution higher than that of the primary image signal and an angle of view equal to or wider than that of the primary image signal. The parallax information generator is configured to generate parallax information, based on the primary image signal and the cutout image signal. In each of the lookup tables, a relation between the parallax information and a distance to an object is predetermined corresponding to a magnification of optical zoom of an imaging unit that images a primary image and outputs the primary image signal. The distance measuring unit is configured to calculate the distance to a predetermined object included in the primary image signal, based on the parallax information and the primary image signal, using the lookup tables.

The imaging apparatus of the present disclosure includes a display unit, a primary imaging unit, a secondary imaging unit, an angle-of-view matching unit, a parallax information generator, a plurality of lookup tables, and a distance measuring unit. The secondary imaging unit is disposed on the backside of an image display surface of the display unit. The display unit is configured to display an imaged image on the image display surface and configured to be openable and closable. The primary imaging unit is configured to image a primary image and output a primary image signal. The secondary imaging unit is configured to image a secondary image having an angle of view equal to or wider than that of the primary image with a resolution higher than that of the primary image and to output a secondary image signal. The angle-of-view matching unit is configured to generate a cutout image signal, based on the primary image signal, by cutting out at least part of the secondary image signal. The parallax information generator is configured to generate parallax information, based on the primary image signal and the cutout image signal. In each of the lookup tables, a relation between the parallax information and a distance to an object is predetermined corresponding to a magnification of optical zoom of the primary imaging unit. The distance measuring unit is configured to calculate the distance to a predetermined object included in the primary image signal, based on the parallax information and the primary image signal, using the lookup tables.

The distance measuring method of the present disclosure includes:
based on a primary image signal, generating a cutout image signal by cutting out at least part of a secondary image signal having a resolution higher than that of the primary image signal and an angle of view equal to or wider than that of the primary image signal;
based on the primary image signal and the cutout image signal, generating parallax information; and
based on the parallax information and the primary image signal, using a plurality of lookup tables in each of which a relation between the parallax information and a distance to an object is predetermined corresponding to a magnification of optical zoom of an imaging unit that images a primary image and outputs the primary image signal, calculating a distance to a predetermined object included in the primary image signal.

### BRIEF DESCRIPTION OF DRAWINGS

FIG. 1 is an appearance diagram of an imaging apparatus in an open state of a monitor in accordance with a first exemplary embodiment.

FIG. 2 is an appearance diagram of the imaging apparatus in a closed state of the monitor in accordance with the first exemplary embodiment.

FIG. 3 is a schematic diagram of a circuit configuration of the imaging apparatus in accordance with the first exemplary embodiment.

FIG. 4 is a diagram showing a configuration of the imaging apparatus divided into blocks based on functions in accordance with the first exemplary embodiment.

FIG. 5 is a schematic diagram showing an example of a flow of image signals processed in the imaging apparatus in accordance with the first exemplary embodiment.

FIG. 6 is a flowchart for explaining operation of the imaging apparatus in imaging a stereoscopic image in accordance with the first exemplary embodiment.

FIG. 7 is a flowchart for explaining distance measuring operation of the imaging apparatus in accordance with the first exemplary embodiment.

FIG. 8 is a flowchart for detailing the distance measuring operation of the imaging apparatus in accordance with the first exemplary embodiment.

FIG. 9 is a schematic diagram showing how the imaging apparatus performs imaging in accordance with the first exemplary embodiment.

FIG. 10 is a schematic diagram showing an example of setting a reference plane for the imaging apparatus in accordance with the first exemplary embodiment.

FIG. 11 is a drawing showing an example of an image that has a calculated distance superimposed thereon and is shown in a display unit of the imaging apparatus in accordance with the first exemplary embodiment.

FIG. 12 is a diagram showing a configuration of an imaging apparatus divided into blocks based on functions in accordance with a second exemplary embodiment.

FIG. 13 is a schematic diagram showing an example of a flow of image signals processed in the imaging apparatus in accordance with the second exemplary embodiment.

### DETAILED DESCRIPTION

Hereinafter, exemplary embodiments are detailed with reference to the accompanying drawings as appropriate. However, unnecessarily detailed description may be omitted. For instance, the detailed description of a matter already well known and the description of substantially identical configurations may be omitted. This is to avoid the following description from being excessively redundant and to help those skilled in the art easily understand the present disclosure.

The accompanying drawings and the following description are provided to help those skilled in the art sufficiently understand the present disclosure. The drawings and the description are not intended to limit the subject matter described in the claims.

### First Exemplary Embodiment

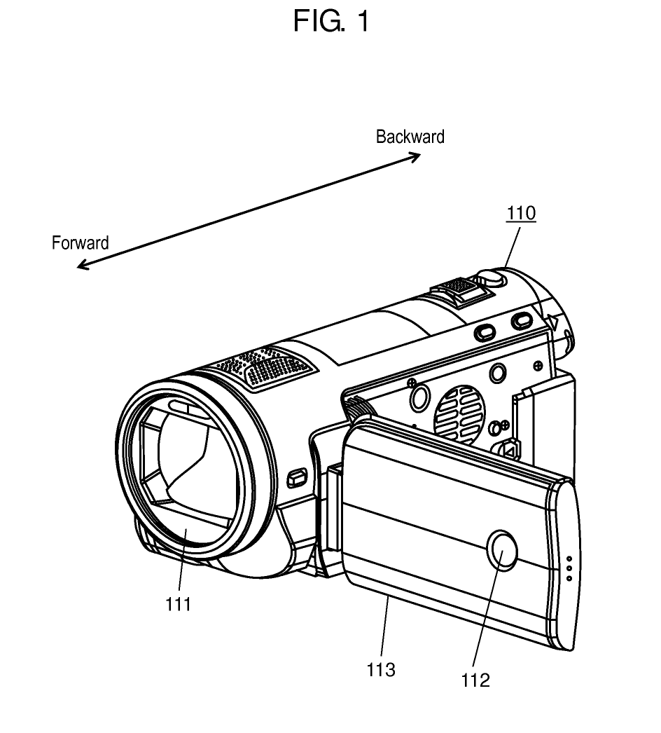

Hereinafter, the first exemplary embodiment is described with reference to FIG. 1 through FIG. 11.

[1-1. Configuration]

FIG. 1 is an appearance diagram of imaging apparatus 110 in an open state of monitor 113 in accordance with the first exemplary embodiment.

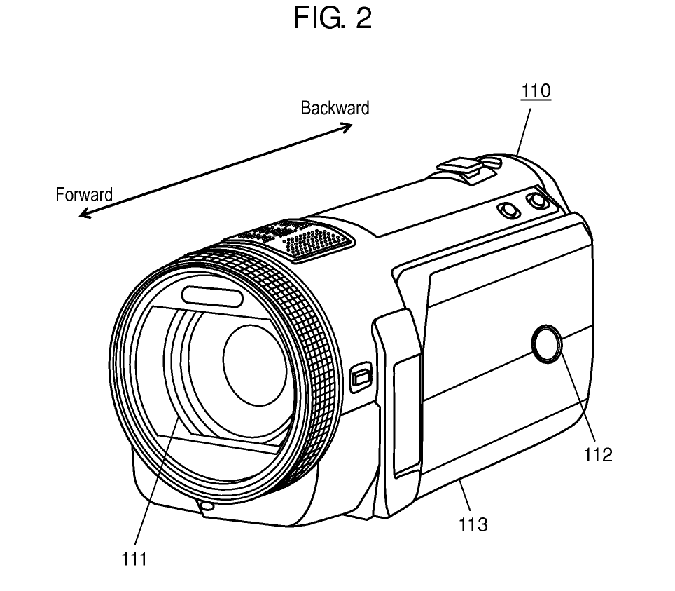

FIG. 2 is an appearance diagram of imaging apparatus 110 in a closed state of monitor 113 in accordance with the first exemplary embodiment.

Imaging apparatus 110 includes monitor 113, an imaging unit including primary lens part 111 (hereinafter being referred to as a “primary imaging unit”), and an imaging unit including secondary lens part 112 (hereinafter being referred to as a “secondary imaging unit). Imaging apparatus 110, which includes a plurality of imaging units in this manner, is capable of imaging still images and moving images in each of the imaging units.

Primary lens part 111 is disposed in the front portion of the body of imaging apparatus 110 so that the imaging direction of the primary imaging unit is directed forward.

As shown in FIG. 1 and FIG. 2, monitor 113 is disposed openably and closably on the body of imaging apparatus 110, and includes a display (not shown in FIG. 1 and FIG. 2) for displaying an imaged image. The display is disposed on the face opposite the imaging direction of the primary imaging unit, that is, on the side where the user (not shown) positioned backward of imaging apparatus 110 can view the display when monitor 113 is opened.

Secondary lens part 112 is disposed in monitor 113 on the side opposite the side having the display and configured to perform imaging in the direction same as the imaging direction of the primary imaging unit when monitor 113 is opened.

In imaging apparatus 110, the primary imaging unit works as a main imaging unit and the secondary imaging unit works as a sub imaging unit. Then, when monitor 113 is set to the open state as shown in FIG. 1, still images for stereoscopic view (hereinafter being referred to as a “stereoscopic image”) and moving images for stereoscopic view (hereinafter being referred to as a “stereoscopic moving image”) can be imaged using these two imaging units. The primary imaging unit as the main unit has an optical zoom function. The user can image a still image or a moving image by setting the zoom function to any zoom magnification.

This exemplary embodiment describes an example where the primary imaging unit images an image of the right-eye viewpoint and the secondary imaging unit images an image of the left-eye viewpoint. Thus, as shown in FIG. 1, imaging apparatus 110 has primary lens part 111 disposed on the right side of the imaging direction and secondary lens part 112 disposed on the left side of the imaging direction. However, this exemplary embodiment is not limited to this configuration. The imaging apparatus may be configured so that the primary imaging unit images an image of the left-eye viewpoint and the secondary imaging unit images an image of the right-eye viewpoint. Hereinafter, the image imaged by the primary imaging unit is defined as a “primary image” and the image imaged by the secondary imaging unit is defined as a “secondary image”.

Secondary lens part 112 included in the secondary imaging unit as the sub unit has an aperture smaller than that of primary lens part 111 and has no optical zoom function. Thus, the volume required to install the secondary imaging unit is smaller than that of the primary imaging unit, and this allows the secondary imaging unit to be installed in monitor 113.

Though detailed later, the following operation is performed in this exemplary embodiment. The image of the right-eye viewpoint imaged by the primary imaging unit is compared with the image of the left-eye viewpoint imaged by the secondary imaging unit so that the amount of parallax (the amount of displacement) is calculated. Further, based on the calculated amount of parallax (displacement), the distance from imaging apparatus 110 to an object is calculated.

This amount of parallax (displacement) is a magnitude of positional displacement of the object generated when the primary image and the secondary image are superimposed at the same angle of view. This displacement is caused by the difference in installation position (parallax) between the primary imaging unit and the secondary imaging unit. To generate a stereoscopic image having a natural stereoscopic effect, it is preferable that the optical axis of the primary imaging unit and the optical axis of the secondary imaging unit are set to the following state. That is, similarly to the parallax direction of a human being, the above two axes are both parallel to the ground and separated with a width substantially equal to the width between the right and left eyes.

For this purpose, in imaging apparatus 110, primary lens part 111 and secondary lens part 112 are disposed so that each of the optical centers thereof is positioned on substantially the same horizontal plane (plane parallel to the ground) when the user holds imaging apparatus 110 normally (in a state of imaging a stereoscopic image). Further, the installation positions of the primary lens part and the secondary lens part are set so that the distance between the optical center of primary lens part 111 and the optical center of secondary lens part 112 ranges from 30 mm to 65 mm inclusive.

In order to generate a stereoscopic image having a natural stereoscopic effect, it is preferable that primary lens part 111 and secondary lens part 112 have a substantially equal distance from the respective installation positions to the object. For this purpose, primary lens part 111 and secondary lens part 112 in imaging apparatus 110 are disposed so as to substantially satisfy the epipolar constraint. That is, primary lens part 111 and secondary lens part 112 are disposed so that each of the optical centers is positioned on a single plane substantially parallel to the imaging face of the imaging device included in the primary imaging unit or the imaging device included in the secondary imaging unit.

These conditions are not necessarily satisfied strictly, and errors within the range in which no practical problems arise are allowed. If these conditions are not satisfied, images can be transformed into those satisfying these conditions by affine transformation, which allows scaling up and down, rotation, parallel translation, or the like of images by computation. Using the images having undergone affine transformation, the amount of parallax (displacement) can be calculated.

In imaging apparatus 110, primary lens part 111 and secondary lens part 112 are disposed so that the optical axis of the primary imaging unit and the optical axis of the secondary imaging unit are parallel to each other (hereinafter, this method being referred to as a “parallel method”). However, primary lens part 111 and secondary lens part 112 may be disposed so that the optical axis of the primary imaging unit crosses the optical axis of the secondary imaging unit at one predetermined point (hereinafter being referred to as a “cross method”). By affine transformation, the images imaged by the parallel method can be transformed into images as if the images are imaged by the cross method.

In the primary image and the secondary image imaged in a state where these conditions are satisfied, the position of the object substantially satisfies the conditions of the epipolar constraint. In this case, in the process of generating a stereoscopic image to be described later, when the position of an object in one image (e.g. the primary image) is determined, the position of the object in the other image (e.g. the secondary image) can be calculated relatively easily. This can reduce the amount of arithmetic operations in the process of generating a stereoscopic image. Conversely, as the number of items that are not satisfied increases, the amount of arithmetic operations for affine transformation, for example, increases. This increases the amount of arithmetic operations in the process of generating a stereoscopic image.

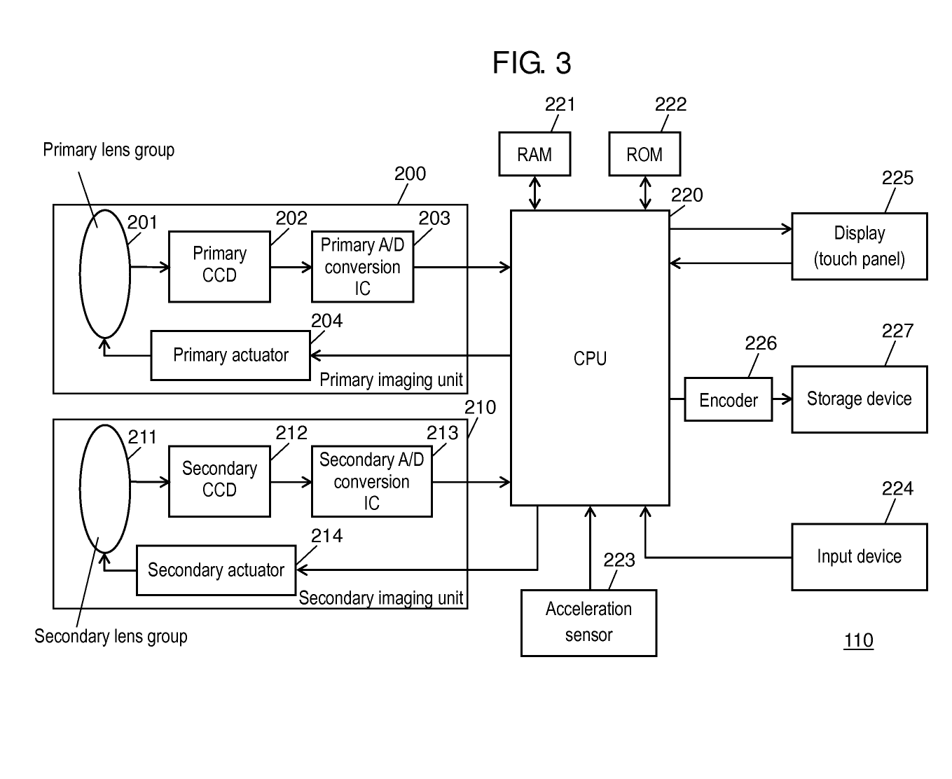

FIG. 3 is a schematic diagram of a circuit configuration of imaging apparatus 110 in accordance with the first exemplary embodiment.

Imaging apparatus 110 includes the following elements: primary imaging unit 200 as the primary imaging unit; secondary imaging unit 210 as the secondary imaging unit; CPU 220; RAM 221; ROM 222; acceleration sensor 223; display 225; encoder 226; storage device 227; and input device 224.

Primary imaging unit 200 includes the following elements: primary lens group 201; primary charge coupled device (CCD) 202 as a primary imaging device; primary A/D conversion IC 203; and primary actuator 204.

Primary lens group 201, which corresponds to primary lens part 111 shown in FIG. 1, is an optical system formed of a plurality of lenses that includes a zoom lens capable of optical zoom and a focus lens capable of focus adjustment. Primary lens group 201 also includes an optical diaphragm (not shown) for adjusting the amount of light (light amount) to be received by primary CCD 202. The light captured through primary lens group 201 undergoes adjustment of the optical zooming, focusing, and light amount in primary lens group 201, and thereafter is focused on the imaging face of primary CCD 202 as an object image. This image is the primary image.

Primary CCD 202 is configured to convert the light received on the imaging face into an electrical signal and to output the signal. This electrical signal is an analog signal whose voltage value changes in response to the intensity of light (the light amount).

Primary A/D conversion IC 203 is configured to convert the analog electrical signal output from primary CCD 202 into a digital electrical signal. This digital signal is the primary image signal.

Primary actuator 204 includes a motor configured to drive the zoom lens and focus lens included in primary lens group 201. This motor is controlled by a control signal output from CPU 220.

In this exemplary embodiment, the following description is provided assuming that primary imaging unit 200 outputs the primary image as an image signal having “1920 pixels in the horizontal direction and 1080 pixels in the vertical direction”. Primary imaging unit 200 is configured so that the primary image unit is capable of not only imaging a still image but also imaging a moving image, and thus is capable of imaging a moving image at a frame rate (e.g. 60 Hz) similar to that of a general moving image. Thus, primary imaging unit 200 is capable of imaging a smooth moving image with high quality. The frame rate means the number of frame images imaged in a unit time (e.g. for one second). When a moving image is imaged at a frame rate of 60 Hz, 60 frame images are continuously imaged for one second.

The number of pixels of the primary image and the frame rate thereof in moving image photography are not limited to the above numerical values, and preferably, are set appropriately for the specifications, for example, for imaging apparatus 110.

Secondary imaging unit 210 includes the following elements: secondary lens group 211; secondary CCD 212 as a secondary imaging device; secondary A/D conversion IC 213; and secondary actuator 214.

Secondary lens group 211, which corresponds to secondary lens part 112 shown in FIG. 1, is an optical system formed of a plurality of lenses that includes a focus lens capable of focus adjustment. The light captured through secondary lens group 211 undergoes focus adjustment in secondary lens group 211 and thereafter is focused on the imaging face of secondary CCD 212 as an object image. This image is the secondary image.

As described above, secondary lens group 211 has no optical zoom function. Thus, the secondary lens group has a single-focus lens in place of an optical zoom lens. Secondary lens group 211 is formed of a lens group smaller than primary lens group 201. The objective lens used in secondary lens group 211 has an aperture smaller than that of the objective lens in primary lens group 201. This configuration makes secondary imaging unit 210 smaller than primary imaging unit 200, and thereby downsizes the whole of imaging apparatus 110, and enhances usability (portability and operability) and flexibility of the installation position of secondary imaging unit 210. Thus, as shown in FIG. 1, secondary imaging unit 210 can be installed in monitor 113.

Similarly to primary CCD 202, secondary CCD 212 is configured to convert the light received on the imaging face into an analog electrical signal and to output the signal. Secondary CCD 212 in this exemplary embodiment has a resolution higher than that of primary CCD 202. Thus, the image signal of the secondary image has a higher resolution and a larger number of pixels than the image signal of the primary image. This is because part of the image signal of the secondary image is extracted and used, or scaled up by electronic zoom. These operations will be detailed later.

Secondary A/D conversion IC 213 is configured to convert the analog electrical signal output from secondary CCD 212 into a digital electrical signal. This digital signal is the secondary image signal.

Secondary actuator 214 includes a motor configured to drive the focus lens included in secondary lens group 211. This motor is controlled by a control signal output from CPU 220.

In this exemplary embodiment, the following description is provided assuming that secondary imaging unit 210 outputs the secondary image as an image signal having “7680 pixels in the horizontal direction and 4320 pixels in the vertical direction”. Similarly to primary imaging unit 200, secondary imaging unit 210 is configured so that the secondary imaging unit is capable of not only imaging a still image but also imaging a moving image. However, since the secondary image signal has a higher resolution and a larger number of pixels than the primary image signal, the frame rate (e.g. 30 Hz) in moving image photography in secondary imaging unit 210 is lower than that in moving image photography in primary imaging unit 200.

The number of pixels of the secondary image signal and the frame rate thereof in moving image photography are not limited to the above numerical values, and preferably, are set appropriately for the specifications, for example, of imaging apparatus 110.

In this exemplary embodiment, the term “imaging” means a series of operations of converting an object image focused on an imaging face of an imaging device into an electrical signal and outputting the electrical signal, as an image signal, from an A/D conversion IC. The primary imaging unit images the primary image and outputs the primary image signal. The secondary imaging unit images the secondary image and outputs the secondary image signal.

This exemplary embodiment describes an example where a CCD is used as each of the primary imaging device and the secondary imaging device. However, each of the primary imaging device and the secondary imaging device may be any imaging device that converts the received light into an electrical signal. For instance, a complementary metal oxide semiconductor (CMOS) may be used as the imaging device.

Read only memory (ROM) 222 is configured to store various types of data such as programs and parameters used for operating CPU 220 so that CPU 220 can optionally read out the stored data. ROM 222, which is formed of non-volatile semiconductor memory elements, is capable of holding the stored data even when imaging apparatus 110 is powered off.

Input device 224 is a generic term of input devices configured to receive instructions from the user. Examples of input device 224 include various buttons such as a power-on/off button and setting button, a touch panel, and a lever that are to be operated by the user. This exemplary embodiment describes an example where a touch panel is provided to display 225. However, input device 224 is not limited to these configurations. For instance, the input device may include a voice input device. Alternatively, the input device may be configured so that all the input operations are made through a touch panel, or conversely, no touch panel is provided and all the input operations are made via buttons, a lever, or the like.

Central processing unit (CPU) 220 is configured to operate in response to the programs and parameters read out from ROM 222, the user's instructions received by input device 224, or the like, and to perform control of the whole of imaging apparatus 110 and various types of arithmetic processing. The various types of arithmetic processing include image signal processing related to the primary image signal and the secondary image signal. This image signal processing will be detailed.

In this exemplary embodiment, a microcomputer is used as CPU 220. For instance, the CPU may be configured to perform the similar operation using a field programmable gate array (FPGA) in place of the microcomputer.

Random access memory (RAM) 221 is formed of non-volatile semiconductor memory elements and configured to temporarily store part of programs to be used for operating CPU 220, the parameters in execution of programs, the instructions from the user, or the like, in response to the instruction from CPU 220. The data stored in RAM 221 can be optionally read out by CPU 220, and optionally rewritten in response to the instruction from CPU 220.

Acceleration sensor 223 is a general acceleration-detecting sensor and configured to detect the movement of imaging apparatus 110 and a change in the posture thereof. Acceleration sensor 223 detects whether imaging apparatus 110 is kept parallel to the ground, for example, and the detection result is displayed in display 225. Thus, by viewing the display, the user can judge whether imaging apparatus 110 is kept parallel to the ground, that is, imaging apparatus 110 is in a state (posture) suitable for imaging a stereoscopic image. Thereby, the user can image a stereoscopic still image or a stereoscopic moving image while keeping imaging apparatus 110 in a suitable posture.

Imaging apparatus 110 may be configured to perform optical control such as camera shake correction, based on the detection result in acceleration sensor 223. Acceleration sensor 223 may be a triaxial gyro scope (triaxial gyro sensor), or configured so that a plurality of sensors combines together.

Display 225 is formed of a general liquid crystal display panel and installed in monitor 113 shown in FIG. 1. Display 225, which has the above touch panel mounted on the surface, is configured to display an image and receive an instruction from the user simultaneously. The images shown on display 225 include the following types: (1) an image being imaged by imaging apparatus 110 (an image based on the image signal output from primary imaging unit 200 or secondary imaging unit 210); (2) an image based on the image signal stored in storage device 227; (3) an image based on the image signal having undergone signal processing in CPU 220; and (4) a menu display screen for displaying various setting items of imaging apparatus 110. Display 225 optionally displays these images or an image obtained by superimposing a plurality of images on each other. Display 225 is not limited to the above configuration, and any image display device that is thin and consumes low electric power may be used. The display may be formed of an electro luminescence (EL) panel, for example.

Encoder 226 is configured to encode, by a predetermined method, the image signals based on the images imaged by imaging apparatus 110 and the information related to the imaged images. This is to reduce the amount of data for storage in storage device 227. This encoding method is a general image compression method, such as MPEG-2 and H.264/MPEG-4 AVC.

Storage device 227 is formed of a hard disk drive (HDD), i.e. a storage device optionally rewritable and having a relatively large capacity, and is configured to store the data encoded by encoder 226, for example, so that the data can be read out. Examples of the data stored in storage device 227 include the image signals of stereoscopic images generated in CPU 220, the information required to display the stereoscopic images, and the image information accompanying the image signals. Storage device 227 may be configured to store the image signals output from primary imaging unit 200 or secondary imaging unit 210 without encoding processing. Storage device 227 is not limited to a HDD, and may be configured to store the data as a detachable memory medium, such as a memory card including semiconductor memory elements and an optical disc.

The above image information means the information related to the image signals. Such information includes the following items: the encoding method of images; bit rate; size of images; resolution; frame rate; types of images to be encoded (e.g. I-Frame, B-Frame, and P-Frame); focusing distance in imaging (distance to a focused object); zoom magnification; whether a stereoscopic image or not; and in the case of a stereoscopic image, identifiers of an image for the right eye and an image for the left eye, parallax information, and information on the distance to an object taken in the image. One or a plurality of pieces of the above information is correlated with the image signals as the image information, and stored in storage device 227.

[1-2. Operation]

A description is provided for the operation of imaging apparatus 110 configured as above.

Hereinafter, a description is provided for major operations performed when imaging apparatus 110 images a stereoscopic image, by dividing the operations into blocks based on functions.

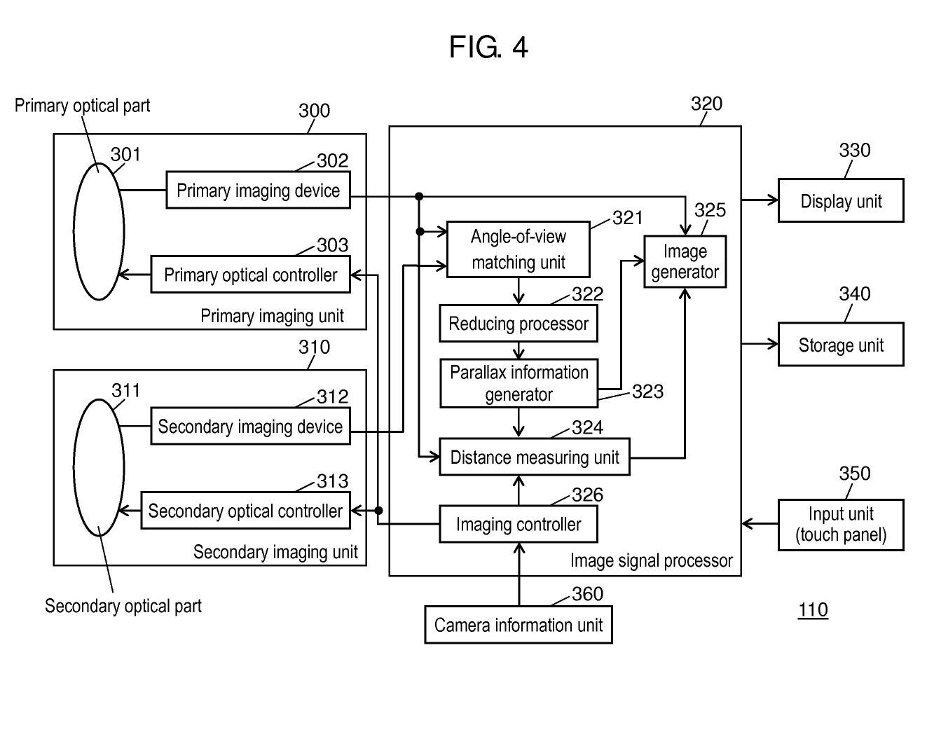

FIG. 4 is a diagram showing a configuration of imaging apparatus 110 divided into blocks based on the functions in accordance with the first exemplary embodiment.

The configuration of imaging apparatus 110 is shown for each major function operated in imaging a stereoscopic image. Then, as shown in FIG. 4, imaging apparatus 110 can be roughly divided into seven blocks: primary imaging unit 300; secondary imaging unit 310; image signal processor 320; display unit 330; storage unit 340; input unit 350; and camera information unit 360.

When processing image signals, image signal processor 320 temporarily stores the image signals in a memory device such as a frame memory. In FIG. 4, such a memory device is omitted.

Primary imaging unit 300 includes primary optical part 301, primary imaging device 302, and primary optical controller 303. Primary imaging unit 300 corresponds to primary imaging unit 200 shown in FIG. 3. Primary optical part 301 corresponds to primary lens group 201. Primary imaging device 302 corresponds to primary CCD 202 and primary A/D conversion IC 203. Primary optical controller 303 corresponds to primary actuator 204. The description of these elements is substantially the same as the above and is omitted.

Secondary imaging unit 310 includes secondary optical part 311, secondary imaging device 312, and secondary optical controller 313. Secondary imaging unit 310 corresponds to secondary imaging unit 210 shown in FIG. 3. Secondary optical unit 311 corresponds to secondary lens group 211. Secondary imaging device 312 corresponds to secondary CCD 212 and secondary A/D conversion IC 213. Secondary optical controller 313 corresponds to secondary actuator 214. The description of these elements is substantially the same as the above and is omitted.

Display unit 330 corresponds to display 225 shown in FIG. 3. Input unit 350 corresponds to input device 224 shown in FIG. 3. The touch panel included in input unit 350 is mounted on the surface of display unit 330, and display unit 330 is capable of displaying an image and receiving an instruction from the user simultaneously. Camera information unit 360 corresponds to acceleration sensor 223 shown in FIG. 3. Storage unit 340 corresponds to storage device 227 shown in FIG. 3. The description of these elements is substantially the same as the above and is omitted.

Image signal processor 320 corresponds to CPU 220 and encoder 226 shown in FIG. 3.

CPU 220 performs control of the whole of imaging apparatus 110 and various types of arithmetic processing. However, in the form of block diagram, FIG. 4 only shows major functions related to the arithmetic processing (image signal processing) and control operation performed in CPU 220 when imaging apparatus 110 images a stereoscopic image. The functions related to the other operations are omitted. This is to allow easy understanding of the operation when imaging apparatus 110 images a stereoscopic image.

Respective functional blocks shown in FIG. 4 as image signal processor 320 only show major functions related to arithmetic processing and control operations performed in CPU 220 in the form of blocks divided based on the functions. The inside of CPU 220 is not physically divided into the respective functional blocks shown in FIG. 4. However, for convenience, the following description is provided assuming that image signal processor 320 has each element shown in FIG. 4.

CPU 220 may be formed of an IC or an FPGA that includes electronic circuitry corresponding to each functional block shown in FIG. 4.

As shown in FIG. 4, image signal processor 320 includes angle-of-view matching unit 321, reducing processor 322, parallax information generator 323, distance measuring unit 324, image generator 325, and imaging controller 326.

Angle-of-view matching unit 321 receives the primary image signal output from primary imaging unit 300 and the secondary image signal output from secondary imaging unit 310. Then, the image signals determined to have an equal imaging range are extracted from respective input image signals.

Primary imaging unit 300 is capable of imaging by optical zoom, and secondary imaging unit 310 performs imaging using a single-focus lens. When each imaging unit is set so that the angle of view of the primary image taken in a wide-angle end position of primary optical unit 301 is equal to or smaller than the angle of view of the secondary image, the imaging range of the secondary image always includes the imaging range of the primary image. For instance, the angle of view of the secondary image imaged without optical zoom is wider than that of the primary image imaged with a large zoom magnification. Thus, in the secondary image, a range wider than that of the primary image is imaged.

The “angle of view” is a range in which an image is imaged and generally expressed as angles.

Then, by a pattern matching generally used for comparison/collation technique, for example, angle-of-view matching unit 321 cuts out a portion corresponding to the imaging range (angle of view) of the primary image, from the secondary image signal. Hereinafter, the image signal cut out from the secondary image signal is referred to as a “cutout image signal”, and the image obtained from the cutout image signal as a “cutout image”. Thus, the cutout image is an image within the range, determined by angle-of-view matching unit 321, to be equal to the imaging range of the primary image.

The difference (parallax) in installation position between primary optical part 301 and secondary optical part 311 causes a difference in the position of the object between the primary image and the secondary image. Thus, it is less possible that the region corresponding to the primary image in the secondary image completely matches with the primary image. Thus, in pattern matching, it is preferable that angle-of-view matching unit 321 searches, in the secondary image signal, the region having the highest similarity to the primary image signal, and cuts out the region, as a cutout image signal, from the secondary image signal.

Next, angle-of-view matching unit 321 outputs the cutout image signal and the primary image signal to reducing processor 322 at the subsequent stage. When the angle of view of the primary image is equal to that of the secondary image, the secondary image signal may be used as the cutout image signal without processing.

The operation in angle-of-view matching unit 321 is not limited to the above. For instance, when the angle of view of the primary image is wider than that of the secondary image, the angle-of-view matching unit may operate to generate a cutout image signal by cutting the region corresponding to the imaging range of the secondary image, from the primary image signal. When a difference in imaging range is present between the primary image and the secondary image, the angle-of-view matching unit may operate to extract the regions having an equal imaging range, from the primary image signal and the secondary image signal and to output the regions to the subsequent stage.

In this exemplary embodiment, the technique for comparing the primary image signal and the secondary image signal in angle-of-view matching unit 321 is not limited to the pattern matching. Other comparison/collation techniques may be used to generate a cutout image signal.

Reducing processor 322 performs reducing processing of reducing the numbers of pixels (amounts of signals) by thinning the pixels of both of the primary image signal and the cutout image signal output from angle-of-view matching unit 321. This is to reduce the amount of arithmetic operations required to calculate the parallax information in parallax information generator 323 at the subsequent stage.

Reducing processor 322 performs reducing processing on both image signals to equalize the numbers of pixels thereof after the reducing processing. This is to perform processing of comparing two image signals in parallax information generator 323 at the subsequent stage with a reduced amount of arithmetic operations and higher accuracy. For instance, assume that the number of pixels (e.g. 3840×2160) of the cutout image signal is four times the number of pixels (e.g. 1920×1080) of the primary image signal, and the primary image signal is reduced so as to have a quarter (e.g. 960×540) of the original number of pixels. In this case, the cutout image signal is reduced so as to have 1/16 (e.g. 960×540) of the original number of pixels. In the reducing processing, it is preferable that filtering processing, for example, is performed to minimize the damage to the information.

Parallax information generator 323 generates parallax information based on the primary image signal and the cutout image signal both having undergone reducing processing in reducing processor 322. Parallax information generator 323 compares the reduced primary image signal and the reduced cutout image signal with each other, and calculates, in units of pixels or in units of blocks each formed of a plurality of pixels, how much the corresponding objects in the two image signals are displaced. This “amount of displacement (displacement amount)” is calculated in the parallax direction, e.g. the direction parallel to the ground when imaging is performed. This “displacement amount” is calculated in the whole region of one image (the image based on the reduced primary image signal or the image based on the reduced cutout image signal) and is correlated with pixels or blocks of the image subjected to calculation. This is parallax information (a depth map).

In this exemplary embodiment, the parallax information (depth map) correlated with the reduced primary image signal is generated. The parallax information generator may be configured to generate parallax information (a depth map) correlated with the reduced cutout image signal.

Distance measuring unit 324 calculates the distance to a predetermined object taken in the image, based on the parallax information (depth map) generated in parallax information generator 323 and the information obtained in imaging the image (information on the zoom magnification and focusing distance). The method for calculating the distance to the predetermined object will be described later. In this exemplary embodiment, the predetermined object is the object that the user specifies, through the touch panel, in the image displayed in display unit 330 (i.e. the object displayed at the position touched by the user). This exemplary embodiment is not limited to this configuration and the predetermined object may be set by other methods, such as setting a focused object to the predetermined object.

Based on the parallax information output from parallax information generator 323, image generator 325 generates a new secondary image signal from the primary image signal. Hereinafter, the new secondary image signal generated from the primary image signal is referred to as a “new secondary image signal”. The image formed by the new secondary image signal is referred to as a “new secondary image”.

In this exemplary embodiment, a stereoscopic image signal is formed so that the primary image signal is an image signal for the right eye and the new secondary image signal generated based on the parallax information in image generator 325 is an image signal for the left eye. The stereoscopic image signal is output from image generator 325.

This stereoscopic image signal is stored in storage unit 340, for example. The stereoscopic image based on the stereoscopic image signal is displayed in display unit 330.

Based on the parallax information, imaging apparatus 110 generates, from the primary image signal (e.g. the image signal for the right eye), the new secondary image signal (e.g. the image signal for the left eye), which forms a pair with the primary image signal. Thus, correcting the parallax information allows adjustment of the stereoscopic effect of the stereoscopic image to be generated. Image generator 325 may be configured to correct the parallax information (depth map) so that the stereoscopic effect of the stereoscopic image can be adjusted, e.g. enhanced and suppressed.

The technique for calculating parallax information (a displacement amount) from two images having parallax, and the technique for generating a new image signal based on the parallax information are already well known. Such a technique is disclosed in Patent Literature 1, for example, and the detailed description of the techniques is omitted.

Next, a description is provided for the operation of imaging a stereoscopic image and the distance measuring operation of calculating a distance to a predetermined object in imaging apparatus 110, with reference to the accompanying drawings. One of the drawings shows an example of how each functional block processes image signals.

Hereinafter, a description is provided for the operation of imaging a stereoscopic image first, and for the distance measuring operation next.

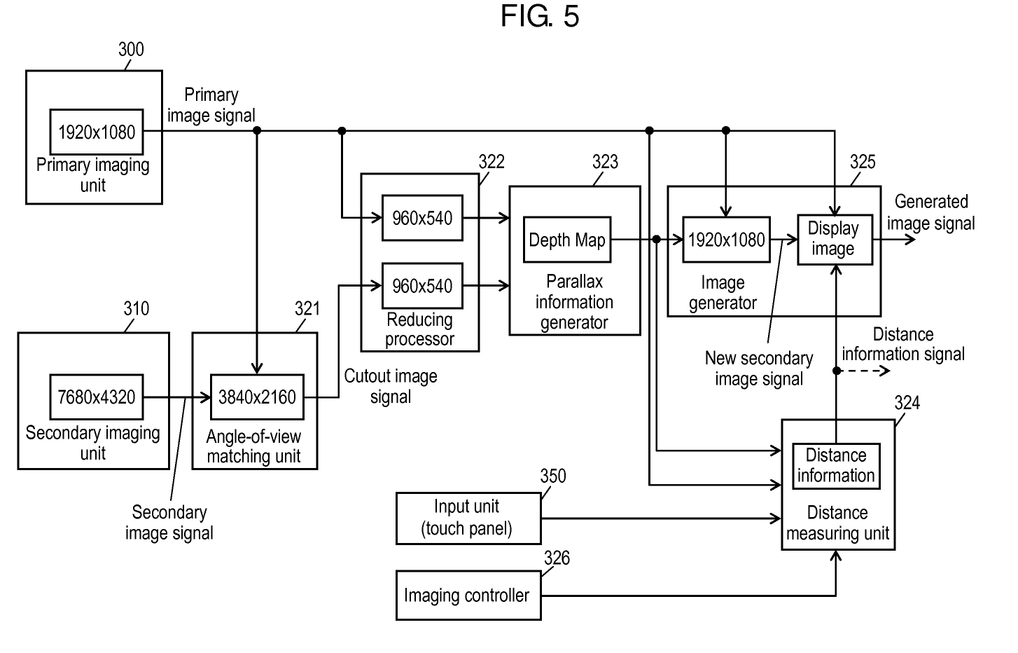

FIG. 5 is a schematic diagram showing an example of a flow of image signals processed in imaging apparatus 110 in accordance with the first exemplary embodiment.

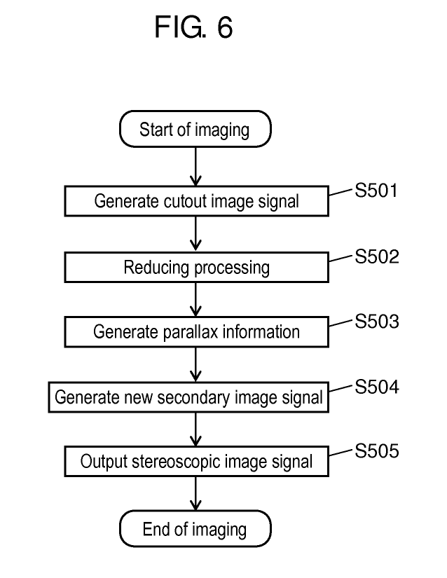

FIG. 6 is a flowchart for explaining operation of imaging apparatus 110 in imaging a stereoscopic image in accordance with the first exemplary embodiment.

As an example, as shown in FIG. 5, the following description is given assuming that primary imaging unit 300 outputs a primary image signal having 1920×1080 pixels and secondary imaging unit 310 outputs a secondary image signal having 7680×4320 pixels.

The numerical values shown in FIG. 5 are only examples and are not intended to limit this exemplary embodiment.

When imaging a stereoscopic image, imaging apparatus 110 mainly performs the following operations.

First, angle-of-view matching unit 321 cuts out, from the secondary image signal, the portion corresponding to the range (angle of view) imaged as the primary image, and thereby generates a cutout image signal (step S501).

Imaging controller 326 of image signal processor 320 controls optical zoom of primary optical part 301 through primary optical controller 303. Thus, image signal processor 320 can acquire the zoom magnification of primary optical part 301 in imaging the primary image, as the information accompanying the primary image. In contrast, secondary optical part 311 is incapable of optical zoom, and the zoom magnification in imaging the secondary image signal is fixed. Based on the above information, angle-of-view matching unit 321 calculates the difference in angle of view between the primary image and the secondary image. Based on the calculation result, the angle-of-view matching unit determines the region corresponding to the imaging range (angle of view) of the primary image, and cuts out the region from the secondary image signal.

At this time, angle-of-view matching unit 321 first cuts a range slightly wider (e.g. by approximately 10%) than the region corresponding to the angle of view of the primary image. This is because the center of the primary image can be slightly displaced from the center of the secondary image.

Next, angle-of-view matching unit 321 performs general pattern matching on this cutout range so as to determine the region corresponding to the imaging range of the primary image, and cuts out the region again. With this operation, a cutout image signal can be generated at high speed by arithmetic processing with relatively low load. The techniques for pattern-matching, for example, by comparing two images having different angles of view and resolutions and determining the regions having common imaging ranges are well known. Thus, the description of such a technique is omitted.

In this manner, angle-of-view matching unit 321 cuts out the region substantially equal to the imaging range of the primary image signal, from the secondary image signal, and thereby generates the cutout image signal.

This exemplary embodiment is not limited to this configuration, and the cutout image signal may be generated only by pattern matching, for example.

FIG. 5 shows an example where the cutout image signal is generated as an image signal having 3840×2160 pixels. The number of pixels of the cutout image signal varies depending on the magnitude of the magnification of optical zoom of primary imaging unit 300. As the zoom magnification in imaging the primary image increases, the number of pixels of the cutout image signal decreases.

Next, reducing processor 322 performs reducing processing so that each of the primary image signal and the cutout image signal has a predetermined number of pixels (step S502).

FIG. 5 shows an example where the predetermined number of pixels is 960×540. When the number of pixels of the primary image signal is 1920×1080, the number of pixels of the primary image signal after reducing processing can be reduced to 960×540 by reducing the primary image signal by half both in the horizontal and vertical directions. When the number of pixels of the cutout image signal is 3840×2160, the number of pixels of the cutout image signal after reducing processing can be reduced to 960×540 by reducing the cutout image signal by a quarter both in the horizontal and vertical directions.

Next, based on the primary image signal and cutout image signal both reduced in reducing processor 322, parallax information generator 323 generates parallax information (a depth map) (step S503).

Next, based on the parallax information (depth map) generated in parallax information generator 323, image generator 325 generates, from the primary image signal, a new secondary image signal, which forms a pair with the primary image signal in a stereoscopic image signal (step S504).

Image generator 325 first extends the parallax information (depth map) in accordance with the number of pixels of the primary image signal. Hereinafter, this extended parallax information (depth map) is referred to as an “extended depth map”. For instance, assume that the parallax information (depth map) is generated based on an image signal having 960×540 pixels and the primary image signal has 1920×1080 pixels. In this case, the extended depth map is generated by extending the original parallax information (depth map) two times both in the horizontal and vertical directions.

Based on the extended depth map, image generator 325 generates a new secondary image signal having 1920×1080 pixels from the primary image signal having 1920×1080 pixels, for example.

At this time, when the new secondary image signal is generated in accordance with an extended depth map based on the parallax information (depth map) to which the above correction (for adjusting the stereoscopic effect of a stereoscopic image) is added, a stereoscopic image signal having an adjusted stereoscopic effect is generated. The processing of correcting the parallax information (depth map) may be performed before or after the processing of generating an extended depth map.

Next, image generator 325 outputs a pair of the primary image signal and the new secondary image signal as a stereoscopic image signal (step S505).

In this exemplary embodiment, the primary image signal is an image signal for the right eye and the new secondary image signal is an image signal for the left eye. However, imaging apparatus 110 may be configured so that the primary image signal is an image signal for the left eye and the new secondary image signal is an image signal for the right eye. The number of pixels of each image signal and the number of pixels of the image signal after reducing processing are not limited to the above numerical values.

Next, a description is provided for the distance measuring operation in imaging apparatus 110.

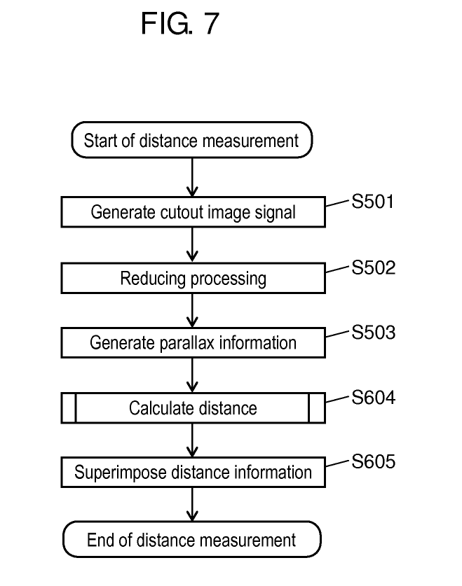

FIG. 7 is a flowchart for explaining the distance measuring operation of imaging apparatus 110 in accordance with the first exemplary embodiment.

In the distance measuring operation for calculating the distance to a predetermined object, imaging apparatus 110 mainly performs the following operations.

Operations in step S501 through step S503 shown in FIG. 7 are substantially the same as the operations in step S501 through step S503 shown in FIG. 6, respectively, and thus the description of these operations is omitted.

Based on the parallax information (depth map) generated in parallax information generator 323 and the primary image signal, distance measuring unit 324 calculates the distance from imaging apparatus 110 to the predetermined object (step S604). The calculated distance is output, as a distance information signal, from distance measuring unit 324 to image generator 325 at the subsequent stage. The operation of calculating the distance in distance measuring unit 324 will be detailed later.

Image generator 325 superimposes the distance information signal output from distance measuring unit 324 on an image signal (e.g. the primary image signal) to be displayed in display unit 330, and outputs the resultant image signal (step S605). In FIG. 5, this image signal is referred to as a “generated image signal”. Display unit 330 displays an image based on the image signal obtained after the distance information signal is superimposed.

Next, the operation in step S604 is detailed.

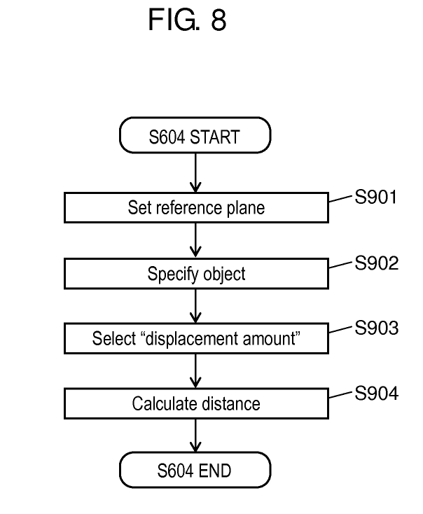

FIG. 8 is a flowchart for detailing the distance measuring operation of imaging apparatus 110 in accordance with the first exemplary embodiment.

In step S604 of calculating the distance to the predetermined object, imaging apparatus 110 mainly performs the following operations.

Distance measuring unit 324 first sets a reference plane in the primary image (step S901).

Distance measuring unit 324 sets, as the reference plane, a region in which the “displacement amount” is “zero”, in the parallax information (depth map) generated in parallax information generator 323.

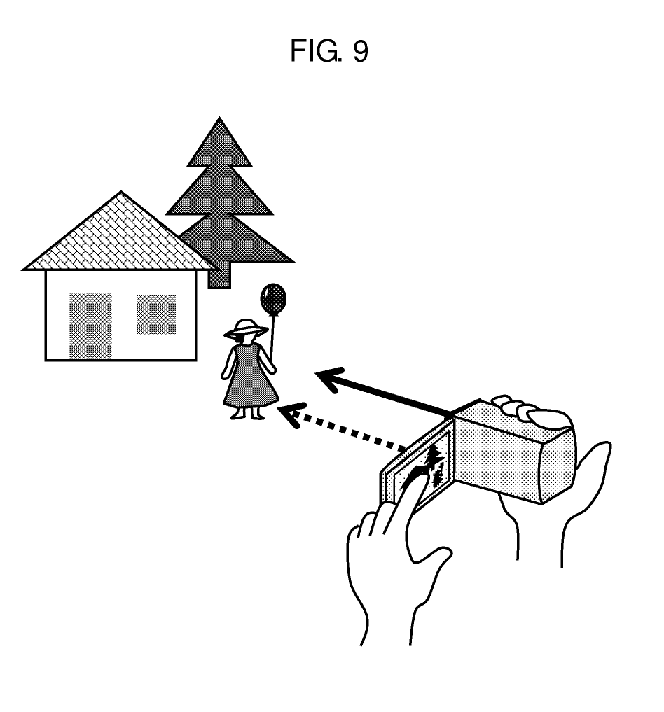

FIG. 9 is a schematic diagram showing how imaging apparatus 110 performs imaging in accordance with the first exemplary embodiment. In FIG. 9, the optical axis of primary imaging unit 300 is shown by a solid line, and the optical axis of secondary imaging unit 310 is shown by a broken line.

When the optical axis of primary imaging unit 300 and the optical axis of secondary imaging unit 310 are set so that imaging is performed by the parallel method, for example, the “displacement amount” in an object in the position at a substantially infinite distance is “zero”. Thus, the substantially infinite distance is set to the reference plane. In this case, as the position of the object becomes closer distance view (closer to imaging apparatus 110), the “displacement amount” increases.

In imaging apparatus 110, the reference plane can be set based on a focused object. By affine transformation, the image imaged by the parallel method can be transformed into an image as if the image is imaged by the cross method. Further, the cross point (the point at which the optical axis of primary imaging unit 300 crosses the optical axis of secondary imaging unit 310) can be set to any position, e.g. the position of the focused object. Hereinafter, the distance from imaging apparatus 110 to the focused object is referred to as a “focusing distance”.

Imaging apparatus 110 can obtain the focusing distance when focus adjustment is performed. The focus lens included in primary optical part 301 is controlled by imaging controller 326 through primary optical controller 303. Moving this focus lens in the direction of the optical axis of primary optical part 301 changes the focusing state of the object image focused on the imaging face of primary imaging device 302. That is, the distance from imaging apparatus 110 to the object focused on the imaging face of primary imaging device 302 (the focusing distance) changes depending on the position of the focus lens. Thus, the position of the focus lens can be correlated with the focusing distance. For instance, when imaging controller 326 (or primary optical controller 303) has information of the positions of the focus lens and the focusing distances correlated with each other, the present focusing distance can be obtained from the present position of the focus lens. That is, imaging controller 326 can obtain the focusing distance when controlling the focus lens through primary optical controller 303. Once the focusing distance is obtained, affine transformation can be performed based on the focusing distance.

When affine transformation is performed so that the position of the focused object is at a virtual cross point of the optical axes, the “displacement amount” in the object distant from imaging apparatus 110 by substantially the focusing distance is “zero”. Thus, the position of the focused object is set to the reference plane. In this case, the object in front of the reference plane and the object behind the reference plane have opposite signs in the calculated “displacement amounts”.

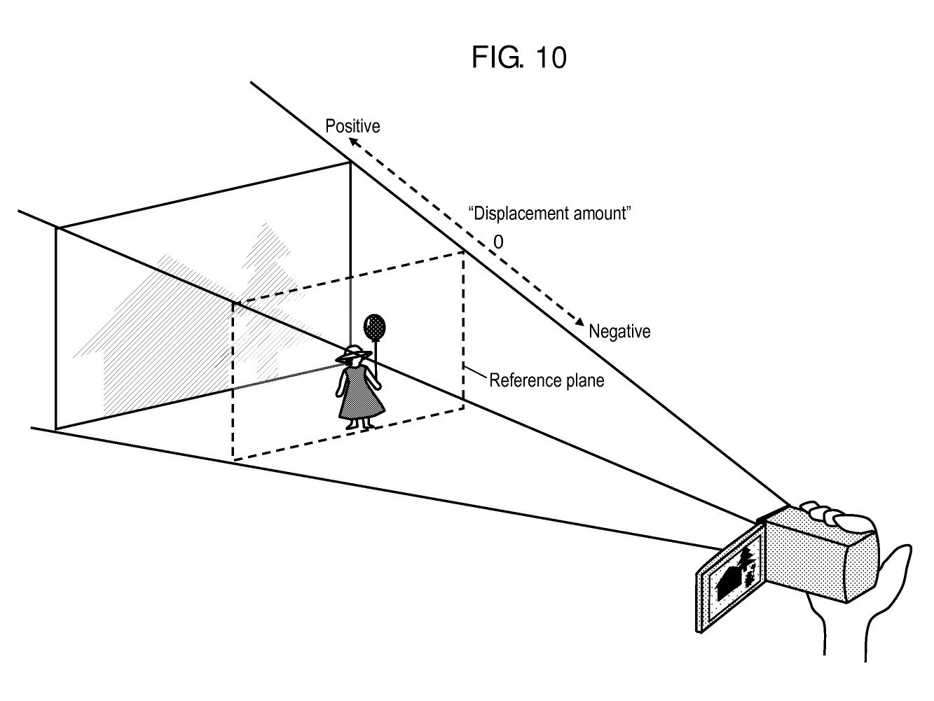

FIG. 10 is a schematic diagram showing an example of setting a reference plane for imaging apparatus 110 in accordance with the first exemplary embodiment. FIG. 10 shows an example where a person having a balloon is focused and the reference plane is set based on this focusing distance. Thus, in the example shown in FIG. 10, the position of the person having the balloon is set to the reference plane.

For instance, the sign of the “displacement amount” of an object behind the reference plane is set “positive” and the sign of the “displacement amount” of an object in front of the reference plane is set “negative”. In this case, as shown in FIG. 10, as the position of the object becomes longer distance view of the reference plane (farther from the reference plane), the “displacement amount” increases in the positive direction. As the position of the object becomes closer distance view of the reference plane (closer to imaging apparatus 110 from the reference plane), the “displacement amount” increases in the negative direction.

In this exemplary embodiment, primary imaging unit 300 and secondary imaging unit 310 are configured to perform imaging by the parallel method. Image signal processor 320 is configured to set, as the reference plane, the position of an object focused in the primary image imaged by primary imaging unit 300 and to perform the distance measuring operation.

However, in this exemplary embodiment, the configuration is not limited to the above, and the following configuration may be used. The position of imaging apparatus 110 is set to the reference plane, a predetermined fixed position is set to the reference plane, or the infinite distance is set to the reference plane as described above. Alternatively, primary imaging unit 300 and secondary imaging unit 310 may be configured to perform imaging by the cross method, and further may be configured to structurally change the cross point of the optical axes in response to the focusing distance.

Next, distance measuring unit 324 sets an object subjected to distance measurement (step S902).

As described above, the touch panel included in input unit 350 is mounted on the surface of display unit 330, and display unit 330 is capable of displaying an image and receiving an instruction from the user simultaneously. In this exemplary embodiment, an object specified by the user through the touch panel (the object displayed at the position touched by the user) in the image (e.g. the primary image) displayed in display unit 330 is subjected to distance measurement. This configuration allows the user to easily specify an object subjected to distance measurement.

This exemplary embodiment is not limited to this configuration, and may have a configuration where the object subjected to distance measurement is selected (set) by other methods. For instance, the distance measuring unit may be configured to set a focused object, for example, as the object subjected to distance measurement.

Next, distance measuring unit 324 selects a “displacement amount” corresponding to the selected object from the parallax information (depth map) (step S903).

Specifically, distance measuring unit 324 reads out the “displacement amounts” of the regions corresponding to the selected object, from the parallax information (depth map), as the “displacement amounts” in the selected object.

From the regions corresponding to the selected object in the parallax information (depth map), a plurality of “displacement amounts” can be read out in response to the size of the object. Thus, distance measuring unit 324 uses the average value of the plurality of “displacement amounts” as the “displacement amount” in the selected object. However, this exemplary embodiment is not limited to this configuration. For instance, the distance measuring unit may be configured to use the “displacement amount” corresponding to one predetermined point (e.g. a central point) in the selected object, as the “displacement amount” in the selected object. Alternatively, the distance measuring unit may be configured to use, in the parallax information (depth map), the “displacement amount” at the position corresponding to the position touched by the user in the touch panel.

Based on the “displacement amount” set in step S903, distance measuring unit 324 calculates the distance (step S904).

Distance measuring unit 324 sets, as the reference plane, the region where the “displacement amount” is “zero” in the parallax information (depth map) generated by parallax information generator 323. Thus, as the “displacement amount” increases, the distance from the reference plane increases. Using this relation, distance measuring unit 324 calculates the distance.

Specifically, distance measuring unit 324 has the information (a lookup table) in which the relation between the magnitudes of the “displacement amounts” and the distances from the reference plane is predetermined, and reads out the distance information, based on the magnitude of the “displacement amount” from this lookup table. Then, the distance measuring unit calculates the distance to the predetermined object by adding the read out distance information to the distance from imaging apparatus 110 to the reference plane (or subtracting the distance information from the distance).

The distance from imaging apparatus 110 to the reference plane can be obtained as a focusing distance as described above and thus the description is omitted.

The relation between the magnitude of the “displacement amount” and the distance from the reference plane varies depending on the magnification of optical zoom in primary optical part 301. Thus, it is preferable that distance measuring unit 324 has a plurality of lookup tables corresponding to the zoom magnifications. However, the magnification of optical zoom consecutively changes, and thus the following configuration, for example, may be used. The distance measuring unit only has lookup tables when the magnifications of optical zoom are integers. When the magnification of optical zoom is not an integer, the distance measuring unit calculates the distance by substituting a plurality of pieces of information read out based on the “displacement amounts” from these lookup tables into a calculation formula set in response to the magnification of optical zoom.

This exemplary embodiment is not limited to this configuration. For instance, distance measuring unit 324 may be configured to have a predetermined calculation formula that expresses the relation between the zoom magnification, magnitude of the “displacement amount”, and distance from the reference plane, and to calculate the distance by substituting a zoom magnification, magnitude of “displacement amount”, or the like into this calculation formula.

As described above, distance measuring unit 324 is capable of acquiring various types of information required for distance measurement, such as a magnification of optical zoom and a focusing distance, as the image information accompanying the image signal.

The relation between the magnitude of the “displacement amount” and the distance from the reference plane is not necessarily linear, and can be non-linear depending on the optical characteristics in primary optical part 301. However, the above method for reading out the distance information from the lookup tables can appropriately address even if any complicated non-linearity is there between the magnitude of the “displacement amount” and the distance from the reference plane.

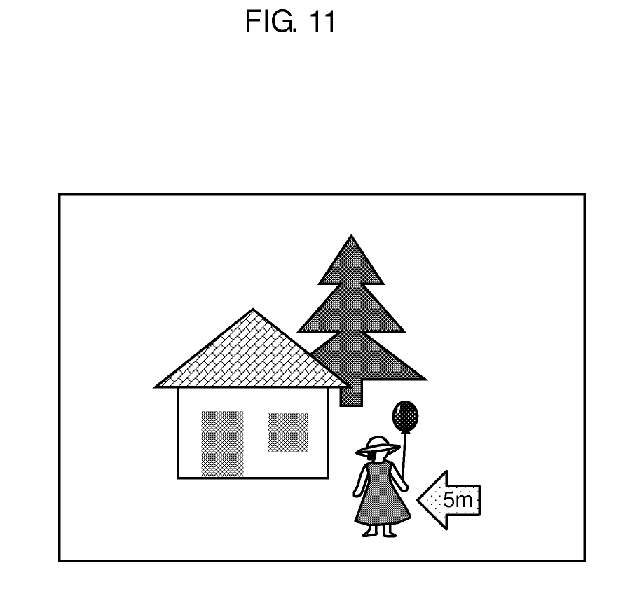

In step S604, the distance to the predetermined object is thus calculated. The figure indicating the calculated distance is superimposed on the display image and displayed in display unit 330 in the form shown in FIG. 11, for example.

FIG. 11 is a drawing showing an example of an image that has a calculated distance superimposed thereon and is shown in display unit 330 of imaging apparatus 110 in accordance with the first exemplary embodiment.

For instance, when distance measuring unit 324 calculates the distance to a predetermined object (a person having a balloon) as “5 m”, display unit 330 displays a figure of “5 m” indicating the result of distance measurement in the vicinity of the person having the balloon.

Thus, in the image displayed in display unit 330, a figure indicating the result of distance measurement is shown in the vicinity of the object selected as the object subjected to distance measurement. Thus, the user can grasp the distance to the specified object at a glance.

When the distance to the predetermined object is displayed in display unit 330, the object subjected to distance measurement may be indicated by a mark such as an arrow as shown in FIG. 11, for example.

This exemplary embodiment is not limited to these configurations, and the numerical value showing the result of distance measurement may be displayed in any portion of display unit 330. The object subjected to distance measurement may be displayed with a different color or a different outline.

Preferably, the zoom magnification of primary optical part 301 and the resolution of secondary imaging device 312 are set so that the resolution of the cutout image signal is equal to or higher than the resolution of the primary image signal when primary optical part 301 is set to a telescopic end position. This is to prevent the cutout image signal from having a resolution lower than that of the primary image signal when primary optical part 301 is set to the telescopic end position. However, this exemplary embodiment is not limited to this configuration.

Preferably, secondary optical part 311 is configured to have an angle of view substantially equal to or wider than that of primary optical part 301 set to a wide-angle (wide) end position. This is to prevent the primary image from having an angle of view wider than that of the secondary image when primary optical part 301 is set to the wide-angle end position. However, this exemplary embodiment is not limited to this configuration, and the angle of view of the primary image when primary optical part 301 is set to the wide-angle end position may be wider than that of the secondary image.

The distance measuring operation in this exemplary embodiment is performed by the instruction from the user, and is not performed when no instruction is given from the user. The configuration of imaging apparatus 110 is not limited to the configuration where the distance measuring operation is performed only in imaging a stereoscopic image. The imaging apparatus may be configured to perform distance measuring operation by performing the steps shown in FIG. 7 and FIG. 8, in response to the instruction from the user, when a stereoscopic image is not imaged but monitor 113 is in the open state.

[1-3. Effect or the Like]

As described above, in this exemplary embodiment, imaging apparatus 110 includes display unit 330 configured to be openable and closable, primary imaging unit 300, secondary imaging unit 310, angle-of-view matching unit 321, parallax information generator 323, a plurality of lookup tables, and distance measuring unit 324. Display unit 330 is configured to display an imaged image on an image display surface. Primary imaging unit 300 is configured to image a primary image and output a primary image signal. Secondary imaging unit 310 is configured to image a secondary image having an angle of view equal to or wider than that of the primary image with a resolution higher than that of the primary image and to output a secondary image signal. Angle-of-view matching unit 321 is configured to generate a cutout image signal, based on the primary image signal, by cutting out at least part of the secondary image signal. Parallax information generator 323 is configured to generate parallax information, based on the primary image signal and the cutout image signal. In each of the lookup tables, a relation between the parallax information and a distance to an object is predetermined corresponding to a magnification of optical zoom of the primary imaging unit 300. Distance measuring unit 324 is configured to calculate the distance to a predetermined object included in the primary image signal, based on the parallax information and the primary image signal, using the lookup tables. Secondary imaging unit 310 is disposed on the backside of the image display surface of display unit 330.

With this configuration, imaging apparatus 110 is capable of imaging a stereoscopic image and calculating a distance to a predetermined object in the imaged image.

To calculate the distance to the predetermined object with higher accuracy, highly-accurate parallax information needs to be generated. For this purpose, two images having parallax need to be captured with high quality.

In order to capture such images, it is preferable that an image for the right eye and an image for the left eye that form a pair are imaged under the equal imaging conditions of the angle of view (imaging range), resolution (the number of pixels), zoom magnification, or the like, and in the states as equal as possible.

However, in order to set such conditions, when the primary imaging unit has an optical zoom function, for example, the secondary imaging unit needs to have a similar optical zoom function. Such a configuration increases the size of the body of an imaging apparatus, thus deteriorating usability as the imaging apparatus.

In imaging apparatus 110 of this exemplary embodiment, primary imaging unit 300 has an optical zoom function and is capable of imaging the primary image with high quality.

In contrast, secondary imaging unit 310 is configured to have no optical zoom function and includes a single-focus lens. This makes secondary imaging unit 310 smaller than primary imaging unit 300, thus downsizing the whole of imaging apparatus 110 and achieving excellent usability (portability and operability). Further, downsized secondary imaging unit 310 has higher flexibility in the installation position, and thus secondary imaging unit 310 can be installed in monitor 113.

However, since the specifications for the optical systems are different between primary imaging unit 300 and secondary imaging unit 310, acquiring highly-accurate parallax information is difficult.

Then, in this exemplary embodiment, highly-accurate parallax information is generated in the following manner. Imaging apparatus 110 is configured as above, the cutout image signal is generated from the secondary image signal, based on the primary image imaged in primary imaging unit 300, and the processing of equalizing the numbers of pixels of the primary image signal and the cutout image signal is performed.

With this configuration, imaging apparatus 110 of this exemplary embodiment is capable of measuring a distance with high accuracy. At this time, distance measuring unit 324 sets a reference plane and calculates the distance from the reference plane, and thus can perform highly-accurate distance measurement even on an unfocused object, for example. Further, based on the highly-accurate parallax information, a new secondary image signal is generated from the primary image signal. Thus, a stereoscopic image signal with high quality can be generated.

Further, in imaging apparatus 110, when secondary imaging unit 310 does not need to be used, the user can keep monitor 113 closed. This configuration enhances the convenience while the user is carrying the imaging apparatus, for example.

### Second Exemplary Embodiment

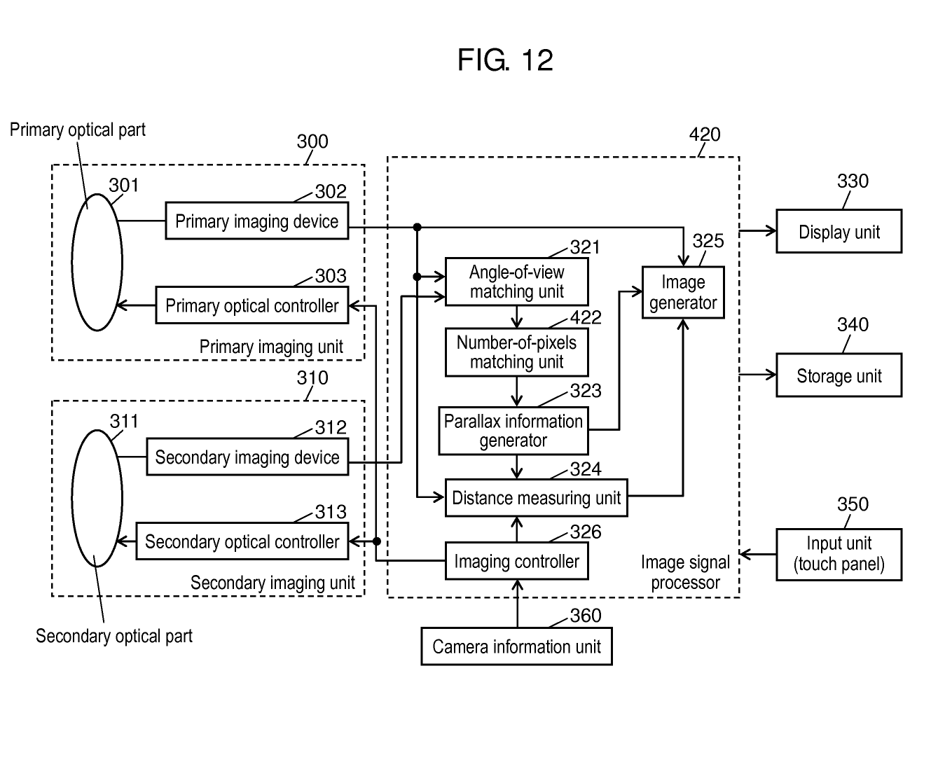

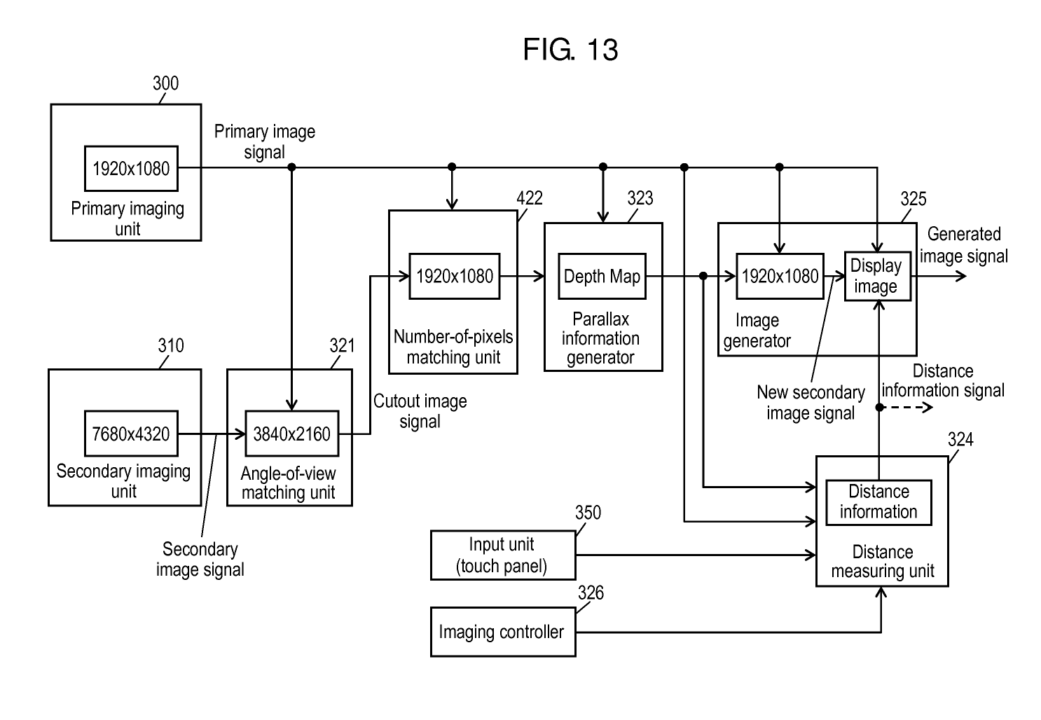

Hereinafter, the second exemplary embodiment is described with reference to FIG. 12 and FIG. 13.

[2-1. Configuration]

Imaging apparatus 120 of the second exemplary embodiment has an appearance, configuration, and functions substantially identical with those of imaging apparatus 110 of the first exemplary embodiment and performs operation substantially similar to that of imaging apparatus 110 of the first exemplary embodiment. Thus, detailed description of these items of the second exemplary embodiment is omitted. The operations performed when the user images a stereoscopic image and measures a distance are substantially the same as those of the first exemplary embodiment. However, the second exemplary embodiment is different from the first exemplary embodiment in processing operation in the image signal processor, and this difference is described hereinafter.

FIG. 12 is a diagram showing a configuration of imaging apparatus 120 divided into blocks based on functions in accordance with the second exemplary embodiment.

FIG. 13 is a schematic diagram showing an example of a flow of image signals processed in imaging apparatus 120 in accordance with the second exemplary embodiment. The numerical values in FIG. 13 only show examples and are not intended to limit this exemplary embodiment.

In the following description, the elements substantially identical in operation, function and configuration with those of the first exemplary embodiment have the same reference marks shown in the first exemplary embodiment, and the description of those elements is omitted.

As shown in FIG. 12, image signal processor 420 of imaging apparatus 120 of this exemplary embodiment is substantially identical in configuration with image signal processor 320 shown in FIG. 4. However image signal processor 420 has number-of-pixels matching unit 422 in place of reducing processor 322. On this point, image signal processor 420 is different from image signal processor 320.

Number-of-pixels matching unit 422 compares the number of pixels of a primary image signal with the number of pixels of a cutout image signal both output from angle-of-view matching unit 321. Then, the number-of-pixels matching unit reduces the number of pixels of one of the image signals having a larger number of pixels to a smaller number of pixels of the other one of the image signals. Thus, the numbers of pixels of both image signals are equalized to each other.

For instance, as shown in FIG. 13, when the number of pixels of the primary image signal is 1920×1080 and the number of pixels of the cutout image signal is 3840×2160, the cutout image signal is reduced by half both in the horizontal and vertical directions so as to form an image signal having 1920×1080 pixels.

When the number of pixels of the primary image signal is larger than the number of pixels of the cutout image signal, number-of-pixels matching unit 422 reduces the number of pixels of the primary image signal to the number of pixels of the cutout image signal.

Number-of-pixels matching unit 422 may set a limitation. For instance, the above processing is performed when the number of pixels of the cutout image signal is equal to or larger than one quarter of the number of pixels of the primary image signal.

[2-2. Operation]

In imaging apparatus 120 configured as above, the above processing of equalizing the numbers of pixels is performed in number-of-pixels matching unit 422 in place of the reducing processing performed in reducing processor 322. Except for this difference, imaging apparatus 120 performs operation substantially the same as that of imaging apparatus 110 of the first exemplary embodiment. Thus, the detailed description of the operation is omitted.

[2-3. Effect or the Like]

Imaging apparatus 120 configured as above does not perform reducing processing on the image signals in reducing processor 322. This makes the accuracy in calculating parallax information in parallax information generator 323 at the subsequent stage higher than that in the configuration of the first exemplary embodiment.

For instance, in the example shown in FIG. 13, parallax information generator 323 generates parallax information (a depth map) based on the image signal having 1920×1080 pixels. This is four times the amount of information of the example shown in the first exemplary embodiment.

Therefore, imaging apparatus 120 of this exemplary embodiment is capable of measuring a distance more accurately than imaging apparatus 110 shown in the first exemplary embodiment.

### Other Exemplary Embodiments

As described above, the first and second exemplary embodiments have been presented as examples of the technique of the present disclosure. However, the technique of the present disclosure is not limited to the above. Modifications, replacements, additions, omissions, or the like can be made on these exemplary embodiments and the present disclosure is intended to cover these variations. Further, respective elements described in the first and second exemplary embodiments may be combined so as to provide new exemplary embodiments.

Hereinafter, these other exemplary embodiments are described.

For instance, an imaging apparatus may be configured to include both of reducing processor 322 of the first exemplary embodiment and number-of-pixels matching unit 422 of the second exemplary embodiment. In this configuration, two types of parallax information (depth maps) can be generated depending on the purpose in the following manner. For instance, for imaging a stereoscopic image (generation of a new secondary image signal), parallax information (a depth map) is generated based on the image signals having passed reducing processor 322. For distance measurement, parallax information (a depth map) is generated based on the image signals having passed number-of-pixels matching unit 422.

This exemplary embodiment describes an example where the imaging apparatus is configured so that primary imaging unit 300 images the primary image and secondary imaging unit 310 images the secondary image. However, for instance, the imaging apparatus may be configured to include a primary image input unit in place of primary imaging unit 300 and a secondary image input unit in place of secondary imaging unit 310 and to capture the primary image through the primary image input unit and the secondary image through the secondary image input unit.

Each of the first and second exemplary embodiments describes a configuration in which the imaging apparatus measures a distance. However, the configuration and operation for distance measurement shown in this exemplary embodiment is also applicable to equipment (e.g. a distance measuring apparatus) that is not intended to image a stereoscopic image.

The configuration and operation shown in each of the first and second exemplary embodiments are also applicable to moving image photography. However, when the primary image signal and the secondary image signal are both for moving images and have different frame rates, angle-of-view matching unit 321 increases the frame rate of one of the image signals having a lower frame rate to a higher frame rate of the other one of the image signals. For instance, when the frame rate of the primary image signal is 60 Hz and the frame rate of the secondary image signal is 30 Hz, the frame rate of the secondary image signal or the cutout image signal is increased to 60 Hz. At this time, any known technique for converting the frame rate may be used. Thus, parallax information is generated in a state where moving image signals can be compared with each other relatively easily. This allows highly-accurate distance measurement also in moving image photography.

The configurations of primary optical part 301 (primary lens group 201) and secondary optical part 311 (secondary lens group 211) are not limited to those shown in the first exemplary embodiment. For instance, each of the optical parts may be configured to include a pan-focus lens (deep focus lens) requiring no focus adjustment, in place of a focus lens capable of focus adjustment. Secondary optical part 311 may be configured to include an optical diaphragm for adjusting the light amount to be received by secondary imaging device 312 (secondary CCD 212).

Secondary optical part 311 may be configured to include an optical zoom lens in place of a single-focus lens. In this case, secondary optical part 311 may be configured to be automatically set to the wide-angle end position when the imaging apparatus images a stereoscopic image or measures a distance, for example.

The imaging apparatus may be configured so that the cutout image signal has a resolution lower than that of the primary image signal when primary optical part 301 is set to a telescopic end position. In this case, the imaging apparatus may be configured to automatically switch from a stereoscopic imaging mode to a general imaging mode when the resolution of the cutout image signal becomes equal to or lower than the resolution of the primary image signal in the process of increasing the zoom magnification of primary optical part 301, for example.

The imaging apparatus may have the following configuration. The imaging apparatus includes a switch that is set to an ON state when monitor 113 is opened to the position suitable for imaging a stereoscopic image or measuring a distance, and is set to OFF in the other cases. Further, only when the switch is set to ON, a stereoscopic image can be imaged or a distance can be measured.

The specific numerical values in the exemplary embodiments only show examples in the exemplary embodiments and are not intended to limit the present disclosure. Preferably, each numerical value is set to a value optimum for the specifications for the image display device, for example.

The present disclosure is applicable to an imaging apparatus that includes a plurality of imaging units and is capable of imaging images for stereoscopic view. Specifically, the present disclosure is applicable to a digital video camera, a digital still camera, a mobile phone having a camera function, a smart phone, or the like that is capable of imaging images for stereoscopic view.

What is claimed is:

1. A distance measuring apparatus comprising:
an angle-of-view matching unit configured to receive a primary image signal and a secondary image signal and to generate a cutout image signal, based on the primary image signal, by cutting out at least part of the secondary image signal having a resolution higher than that of the primary image signal and an angle of view equal to or wider than that of the primary image signal;
a parallax information generator configured to generate parallax information, based on the primary image signal and the cutout image signal;
a plurality of lookup tables in each of which a relation between the parallax information and a distance to an object is predetermined corresponding to a magnification of optical zoom of an imaging unit that images a primary image and outputs the primary image signal; and
a distance measuring unit configured to calculate a distance to a predetermined object included in the primary image signal, based on the parallax information and the primary image signal, using the lookup tables.

2. The distance measuring apparatus of claim 1, further comprising a reducing processor configured to reduce a number of pixels of the primary image signal and a number of pixels of the cutout image signal to a predetermined number of pixels,
wherein the parallax information generator is configured to generate the parallax information, based on the primary image signal having undergone the reducing processing and the cutout image signal having undergone the reducing processing.

3. The distance measuring apparatus of claim 1, further comprising a number-of-pixels matching unit configured to compare a number of pixels of the primary image signal and a number of pixels of the cutout image signal and to reduce the number of pixels of one of the image signals having a larger number of pixels, based on a smaller number of pixels of an other of the imaging signals,
wherein the parallax information generator is configured to calculate the parallax information, based on the image signal having the smaller number of pixels and the image signal having the number of pixels reduced in the number-of-pixels matching unit.

4. An imaging apparatus comprising:
a display unit configured to display an imaged image on an image display surface and configured to be openable and closable;
a primary imaging unit configured to image a primary image and output a primary image signal;
a secondary imaging unit configured to image a secondary image having an angle of view equal to or wider than that of the primary image with a resolution higher than that of the primary image and to output a secondary image signal;
an angle-of-view matching unit configured to generate a cutout image signal, based on the primary image signal, by cutting out at least part of the secondary image signal;
a parallax information generator configured to generate parallax information, based on the primary image signal and the cutout image signal;
a plurality of lookup tables in each of which a relation between the parallax information and a distance to an object is predetermined corresponding to a magnification of optical zoom of the primary imaging unit; and
a distance measuring unit configured to calculate a distance to a predetermined object included in the primary image signal, based on the parallax information and the primary image signal, using the lookup tables,
wherein the secondary imaging unit is disposed on a backside of the image display surface of the display unit.

5. The imaging apparatus of claim 4, further comprising an image generator configured to generate a new secondary image signal from the primary image signal, based on the parallax information, and to display, on the image display surface, an image based on at least one of the primary image signal and the new secondary image signal,
wherein the display unit includes, on the image display surface, a touch panel configured to detect a position touched by a user,
the distance measuring unit is configured to calculate the distance by setting, as the predetermined object, an object that is displayed at the position detected by the touch panel in the image displayed on the image display surface, and
the image generator is configured to superimpose a figure indicating the distance on the image so that the figure is displayed on the image display surface.

6. The imaging apparatus of claim 4, wherein
the primary imaging unit includes:
a primary optical part having an optical zoom function; and
a primary imaging device configured to convert light transmitted through the primary optical part into an electrical signal and to output the primary image signal,
the secondary imaging unit includes:
a secondary optical part having an angle of view equal to or wider than that of the primary optical part; and
a secondary imaging device configured to convert light transmitted through the secondary optical part into an electrical signal with a resolution higher than that of the primary imaging device and to output the secondary image signal, and
the secondary imaging unit is configured to perform imaging in a direction substantially identical with an imaging direction of the primary imaging unit when the display unit is opened.

7. The imaging apparatus of claim 4, further comprising a reducing processor configured to reduce a number of pixels of the primary image signal and a number of pixels of the cutout image signal to a predetermined number of pixels,
wherein the parallax information generator generates the parallax information, based on the primary image signal having undergone the reducing processing and the cutout image signal having undergone the reducing processing.

8. The imaging apparatus of claim 4, further comprising a number-of-pixels matching unit configured to compare a number of pixels of the primary image signal and a number of pixels of the cutout image signal and to reduce the number of pixels of one of the image signals having a larger number of pixels, based on a smaller number of pixels of an other of the imaging signals,
wherein the parallax information generator is configured to calculate the parallax information, based on the image signal having the smaller number of pixels and the image signal having the number of pixels reduced in the number-of-pixels matching unit.

9. A distance measuring method comprising:
based on a primary image signal, generating a cutout image signal by cutting out at least part of a secondary image signal having a resolution higher than that of the primary image signal and an angle of view equal to or wider than that of the primary image signal;
based on the primary image signal and the cutout image signal, generating parallax information; and
based on the parallax information and the primary image signal, using a plurality of lookup tables in each of which a relation between the parallax information and a distance to an object is predetermined corresponding to a magnification of optical zoom of an imaging unit that images a primary image and outputs the primary image signal, calculating a distance to a predetermined object included in the primary image signal.

10. The distance measuring method of claim 9, wherein
a number of pixels of the primary image signal and a number of pixels of the cutout image signal are reduced to a predetermined number of pixels, and
the parallax information is generated, based on the primary image signal having undergone the reducing processing and the cutout image signal having undergone the reducing processing.

11. The distance measuring method of claim 9, wherein
a number of pixels of the primary image signal and a number of pixels of the cutout image signal are compared with each other and the number of pixels of one of the image signals having a larger number of pixels is reduced, based on a smaller number of pixels of an other of the imaging signals, and
the parallax information is calculated based on the image signal having the smaller number of pixels and the image signal having the number of pixels reduced.

12. The distance measuring apparatus of claim 1, wherein
the lookup tables include a lookup table in which the magnification of the optical zoom is an integer, and
when a magnification of the optical zoom is not an integer, the distance measuring unit calculates the distance to the predetermined object, using a plurality of pieces of distance information read out based on the parallax information from the lookup tables.

13. The imaging apparatus of claim 4, wherein
the lookup tables include a lookup table in which the magnification of optical zoom is an integer, and
when a magnification of the optical zoom is not an integer, the distance measuring unit calculates the distance to the predetermined object, using a plurality of pieces of distance information read out based on the parallax information from the lookup tables.

14. The distance measuring method of claim 9, wherein
the lookup tables include a lookup table in which the magnification of the optical zoom is an integer, and
when a magnification of the optical zoom is not an integer, the distance to the predetermined object is calculated, using a plurality of pieces of distance information read out based on the parallax information from the lookup tables.
